(19) United States
(12) Patent Application Publication
(10) Pub. No.: US 2014/0120513 A1
(43) Pub. Date: May 1, 2014

(54) Question and Answer System Providing Indications of Information Gaps

(71) Applicant: INTERNATIONAL BUSINESS MACHINES CORPORATION, (US)

(72) Inventors: Jana H. Jenkins, Raleigh, NC (US); David C. Steinmetz, Bothell, WA (US); Wlodek W. Zadrozny, Tarrytown, NY (US)

(73) Assignee: INTERNATIONAL BUSINESS MACHINES CORPORATION, Armonk, NY (US)

(21) Appl. No.: 13/660,711

(22) Filed: Oct. 25, 2012

(51) Int. Cl. G09B 7/00

(52) U.S. Cl. 434/362

(57) ABSTRACT

Mechanisms are provided for identifying information gaps in electronic content. These mechanisms receive the electronic content to be analyzed and analyze the electronic content to identify at least one of topics or questions within the electronic content to produce a collection of at least one of topics or questions associated with the electronic content. These mechanisms further compare the collection to the electronic content, and to a corpus of previously analyzed electronic content, to produce a set of information gaps in the electronic content. Moreover, the mechanisms output a notification of the set of information gaps to a user associated with the electronic content.

### BACKGROUND

The present application relates generally to an improved data processing apparatus and method and more specifically to mechanisms for providing indications of information gaps in a question and answer system.

With the increased usage of computing networks, such as the Internet, humans are currently inundated and overwhelmed with the amount of information available to them from various structured and unstructured sources. However, information gaps abound as users try to piece together what they can find that they believe to be relevant during searches for information on various subjects. To assist with such searches, recent research has been directed to generating Question and Answer (QA) systems which may take an input question, analyze it, and return results indicative of the most probable answer to the input question. QA systems provide automated mechanisms for searching through large sets of sources of content, e.g., electronic documents, and analyze them with regard to an input question to determine an answer to the question and a confidence measure as to how accurate an answer is for answering the input question.

One such QA system is the Watson™ system available from International Business Machines (IBM) Corporation of Armonk, N.Y. The Watson™ system is an application of advanced natural language processing, information retrieval, knowledge representation and reasoning, and machine learning technologies to the field of open domain question answering. The Watson™ system is built on IBM's DeepQA™ technology used for hypothesis generation, massive evidence gathering, analysis, and scoring. DeepQA™ takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

Various United States Patent Application Publications describe various types of question and answer systems. U.S. Patent Application Publication No. 2011/0125734 discloses a mechanism for generating question and answer pairs based on a corpus of data. The system starts with a set of questions and then analyzes the set of content to extract answer to those questions. U.S. Patent Application Publication No. 2011/0066587 discloses a mechanism for converting a report of analyzed information into a collection of questions and determining whether answers for the collection of questions are answered or refuted from the information set. The results data are incorporated into an updated information model.

### SUMMARY

In one illustrative embodiment, a method, in a data processing system, is provided for identifying information gaps in electronic content. The method comprises receiving, in the data processing system, the electronic content to be analyzed and analyzing, by the data processing system, the electronic content to identify at least one of topics or questions within the electronic content to produce a collection of at least one of topics or questions associated with the electronic content. The method further comprises comparing, by the data processing system, the collection to the electronic content, and to a corpus of previously analyzed electronic content, to produce a set of information gaps in the electronic content. Moreover, the method comprises outputting, by the data processing system, a notification of the set of information gaps to a user associated with the electronic content.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a question/answer creation (QAC) system in a computer network;

FIG. 2 depicts a schematic diagram of one embodiment of the QAC system of FIG. 1;

FIG. 3 depicts a flowchart diagram of one embodiment of a method for question/answer creation for a document;

FIG. 4 depicts a flowchart diagram of one embodiment of a method for question/answer creation for a document;

FIG. 5 depicts an example diagram of one illustrative embodiment of a QAC system incorporating content gap checking logic in accordance with one illustrative embodiment; and

FIG. 6 depicts a flowchart diagram outlining an example operation for performing content gap checking in accordance with one illustrative embodiment.

### DETAILED DESCRIPTION

The illustrative embodiments provide mechanisms for providing indications of information gaps in a question and answer (QA) system. The illustrative embodiments may be used to notify authors and users of such information gaps so that documents and other sources of content used as a basis for the question and answer system may be updated as appropriate to address these information gaps. Moreover, the mechanisms of the illustrative embodiments may not only identify information gaps with regard to questions posed or input to the QA system, but may identify other questions that should have answers in the corresponding source of content, but for which no answer is present, and thereby identify information gaps for questions not yet posed or input to the QA system.

As mentioned above, QA systems provide an automated tool for searching large sets of electronic documents, or other sources of content, based on an input question to determine a probable answer to the input question and a corresponding confidence measure. IBM's Watson™ is one such QA system. While these QA systems may provide an automated tool for determining answers to input questions, one functionality they lack is the ability to identify gaps in information. The ability to identify these gaps and to begin the process of signaling the missing information to the author, creator, or provider of the electronic documents or other sources of information would be extremely powerful and helpful to users as they try to obtain the “total answer” to their questions.

The illustrative embodiments provide mechanisms for identifying information gaps when searching electronic documents for answers to questions, either in response to a user inputting a question for which the user wishes an answer to be provided, or in response to a content provider providing a new electronic document as a source of content for use by a QA system and for inclusion in a corpus of content, e.g., a collection of electronic documents that may be operated on by the QA system. The illustrative embodiments may be implemented in conjunction with a QA system, for example, as an extension of the QA system which provides additional functionality that may be implemented in parallel with the other functions of the QA system. For example, the illustrative embodiments may be used to extend the functionality of the Watson™ QA system available from IBM Corporation.

The illustrative embodiments may operate in concert with the QA system such that the QA system not only scans the available content in the corpus of content, e.g., collection of electronic documents available to the QA system, looking for answers to questions, but can note and confirm that the QA system found, or did not find, the answers to the input or identified questions, e.g., a collection of questions created by content creators, especially for technical and scientific domains. If the QA system is expecting to find an answer to a question based on analysis of portions of content, e.g., a title, a short description, metadata, or other indication of answers to questions within the content, and the QA system cannot find the information to provide an answer to the question in the content, then the QA system has identified an accuracy, information quality, or information gap issue. The QA system, implementing the mechanisms of one or more of the illustrative embodiments, can provide this information regarding the accuracy, information quality, or information gap issue, back to the content author, owner, or provider to prompt those persons to add additional content to provide the answers to the question, rework the portions of the content used to determine that an answer should be present, or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

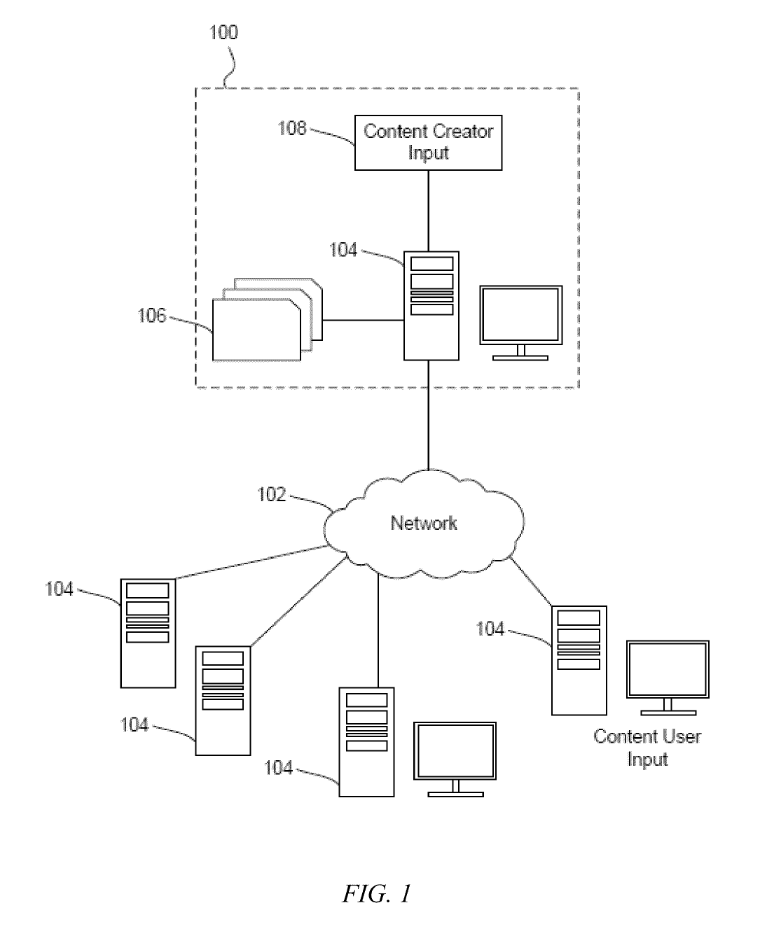

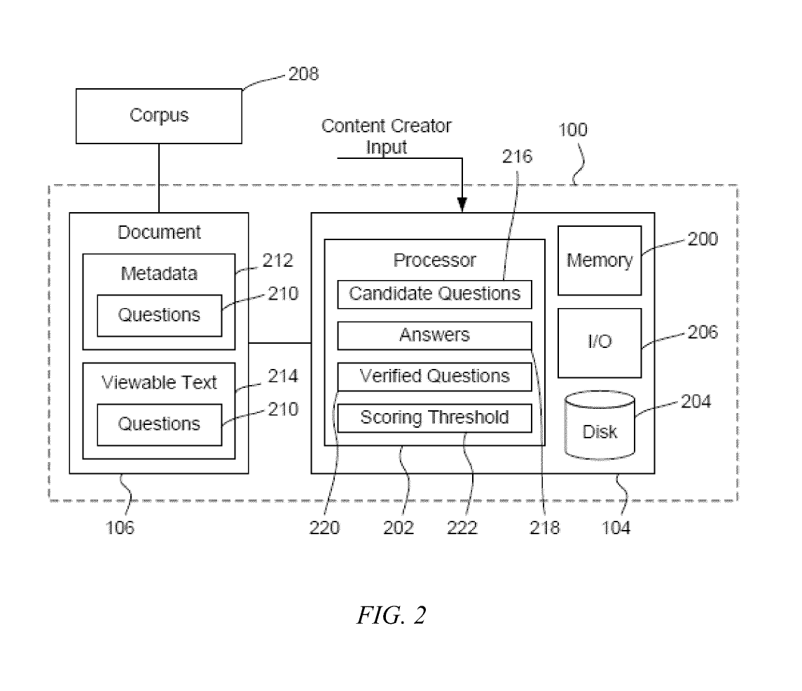

Thus, the illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIGS. 1-4 are directed to describing an example Question and Answer Creation (QAC) system, methodology, and computer program product with which the mechanisms of the illustrative embodiments may be implemented. As will be discussed in greater detail hereafter, the illustrative embodiments may be integrated in, and may augment and extend the functionality of, these QAC mechanisms. Thus, it is important to first have an understanding of how question and answer creation may be implemented before describing how the mechanisms of the illustrative embodiments are integrated in and augment such question and answer creation. It should be appreciated that the QAC mechanisms described in FIGS. 1-4 are only examples and are not intended to state or imply any limitation with regard to the type of QAC mechanisms with which the illustrative embodiments may be implemented. Many modifications to the example QAC system shown in FIGS. 1-4 may be implemented in various embodiments of the present invention without departing from the spirit and scope of the present invention.

QAC mechanisms operate by accessing information from a corpus of data (or content), analyzing it, and then generating answer results based on the analysis of this data. Accessing information from a corpus of data typically includes: a database query that answers questions about what is in a collection of structure records; and a search that delivers a collection of document links in response to a query against a collection of unstructured data (text, markup language, etc.). Conventional question answering systems are capable of generating question and answer pairs based on the corpus of data, verifying answers to a collection of questions for the corpus of data, correcting errors in digital text using a corpus of data, and selecting answers to questions from a pool of potential answers. However, such systems may not be capable of proposing and inserting new questions which may not have been specified previously in conjunction with the corpus of data. Also, such systems may not validate the questions in accordance with the content of the corpus of data.

Content creators, such as article authors, may determine use cases for products, solutions, and service before writing the content. Consequently, the content creators may know what questions the content is intended to answer in a particular topic addressed by the content. Categorizing the questions, such as in terms of roles (, type of information, tasks, or the like, associated with the question, in each document of a document corpus may allow the system to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QAC system.

FIG. 1 depicts a schematic diagram of one illustrative embodiment of a question/answer creation (QAC) system 100 in a computer network 102. One example of a question/answer generation which may be used in conjunction with the principles described herein is described in U.S. Patent Application Publication No. 2011/0125734, which is herein incorporated by reference in its entirety. The QAC system 100 may include a computing device 104 connected to the computer network 102. The network 102 may include multiple computing devices 104 in communication with each other and with other devices or components. The QAC system 100 and network 102 may enable question/answer (QA) generation functionality for one or more content users. Other embodiments of the QAC system 100 may be used with components, systems, sub-systems, and/or devices other than those that are depicted herein.

The QAC system 100 may be configured to receive inputs from various sources. For example, the QAC system 100 may receive input from the network 102, a corpus of electronic documents 106 or other data, a content creator 108, content users, and other possible sources of input. In one embodiment, some or all of the inputs to the QAC system 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that the QAC system 100 may operate in environments of any size, including local and global, e.g., the Internet.

In one embodiment, the content creator creates content in a document 106 for use with the QAC system 100. The document 106 may include any file, text, article, or source of data for use in the QAC system 100. Content users may access the QAC system 100 via a network connection or an Internet connection to the network 102, and may input questions to the QAC system 100 that may be answered by the content in the corpus of data. In one embodiment, the questions may be formed using natural language. The QAC system 100 may interpret the question and provide a response to the content user containing one or more answers to the question. In some embodiments, the QAC system 100 may provide a response to content users in a ranked list of answers.

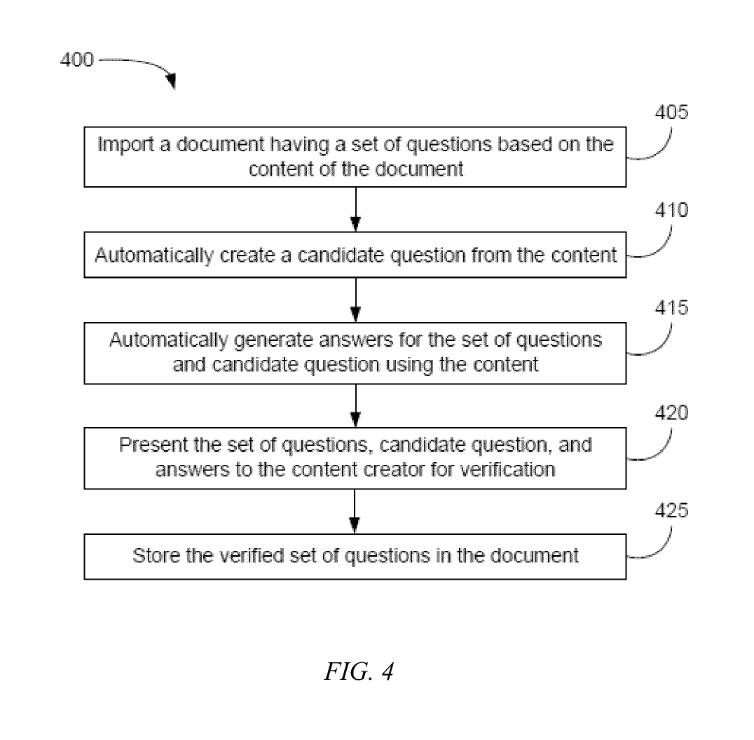

FIG. 2 depicts a schematic diagram of one embodiment of the QAC system 100 of FIG. 1. The depicted QAC system 100 includes various components, described in more detail below, that are capable of performing the functions and operations described herein. In one embodiment, at least some of the components of the QAC system 100 are implemented in a computer system. For example, the functionality of one or more components of the QAC system 100 may be implemented by computer program instructions stored on a computer memory device 200 and executed by a processing device such as a CPU. The QAC system 100 may include other components, such as a disk storage drive 204, and input/output devices 206, and at least one document 106 from a corpus 208. Some or all of the components of the gestural control system 100 may be stored on a single computing device 104 or on a network of computing devices 104, including a wireless communication network. The QAC system 100 may include more or fewer components or subsystems than those depicted herein. In some embodiments, the QAC system 100 may be used to implement the methods described herein as depicted in FIG. 4.

In one embodiment, the QAC system 100 includes at least one computing device 104 with a processor 202 for performing the operations described herein in conjunction with the QAC system 100. The processor 202 may include a single processing device or multiple processing devices. The processor 202 may have multiple processing devices in different computing devices 104 over a network such that the operations described herein may be performed by one or more computing devices 104. The processor 202 is connected to and in communication with the memory device. In some embodiments, the processor 202 may store and access data on the memory device 200 for performing the operations described herein. The processor 202 may also be connected to a storage disk 204, which may be used for data storage, for example, for storing data from the memory device 200, data used in the operations performed by the processor 202, and software for performing the operations described herein.

In one embodiment, the QAC system 100 imports a document 106. The electronic document 106 may be part of a larger corpus 208 of data or content, which may contain electronic documents 106 related to a specific topic or a variety of topics. The corpus 208 of data may include any number of documents 106 and may be stored in any location relative to the QAC system 100. The QAC system 100 may be capable of importing any of the documents 106 in the corpus 208 of data for processing by the processor 202. The processor 202 may communicate with the memory device 200 to store data while the corpus 208 is being processed.

The document 106 may include a set of questions 210 generated by the content creator at the time the content was created. When the content creator creates the content in the document 106, the content creator may determine one or more questions that may be answered by the content or for specific use cases for the content. The content may be created with the intent to answer specific questions. These questions may be inserted into the content, for example, by inserting the set of questions 210 into the viewable content/text 214 or in metadata 212 associated with the document 106. In some embodiments, the set of questions 210 shown in the viewable text 214 may be displayed in a list in the document 106 so that the content users may easily see specific questions answered by the document 106.

The set of questions 210 created by the content creator at the time the content is created may be detected by the processor 202. The processor 202 may further create one or more candidate questions 216 from the content in the document 106. The candidate questions 216 include questions that are answered by the document 106, but that may not have been entered or contemplated by the content creator. The processor 202 may also attempt to answer the set of questions 210 created by the content creator and candidate questions 216 extracted from the document 106, “extracted” meaning questions that are not explicitly specified by the content creator but are generated based on analysis of the content.

In one embodiment, the processor 202 determines that one or more of the questions are answered by the content of the document 106 and lists or otherwise marks the questions that were answered in the document 106. The QAC system 100 may also attempt to provide answers 218 for the candidate questions 216. In one embodiment, the QAC system 100 answers 218 the set of questions 210 created by the content creator before creating the candidate questions 216. In another embodiment, the QAC system 100 answers 218 the questions and the candidate questions 216 at the same time.

The QAC system 100 may score question/answer pairs generated by the system. In such an embodiment, question/answer pairs that meet a scoring threshold are retained, and question/answer pairs that do not meet the scoring threshold 222 are discarded. In one embodiment, the QAC system 100 scores the questions and answers separately, such that questions generated by the system 100 that are retained meet a question scoring threshold, and answers found by the system 100 that are retained meet an answer scoring threshold. In another embodiment, each question/answer pair is scored according to a question/answer scoring threshold.

After creating the candidate questions 216, the QAC system 100 may present the questions and candidate questions 216 to the content creator for manual user verification. The content creator may verify the questions and candidate questions 216 for accuracy and relatedness to the content of the document 106. The content creator may also verify that the candidate questions 216 are worded properly and are easy to understand. If the questions contain inaccuracies or are not worded properly, the content creator may revise the content accordingly. The questions and candidate questions 216 that have been verified or revised may then be stored in the content of the document 106 as verified questions, either in the viewable text 214 or in the metadata 212 or both.

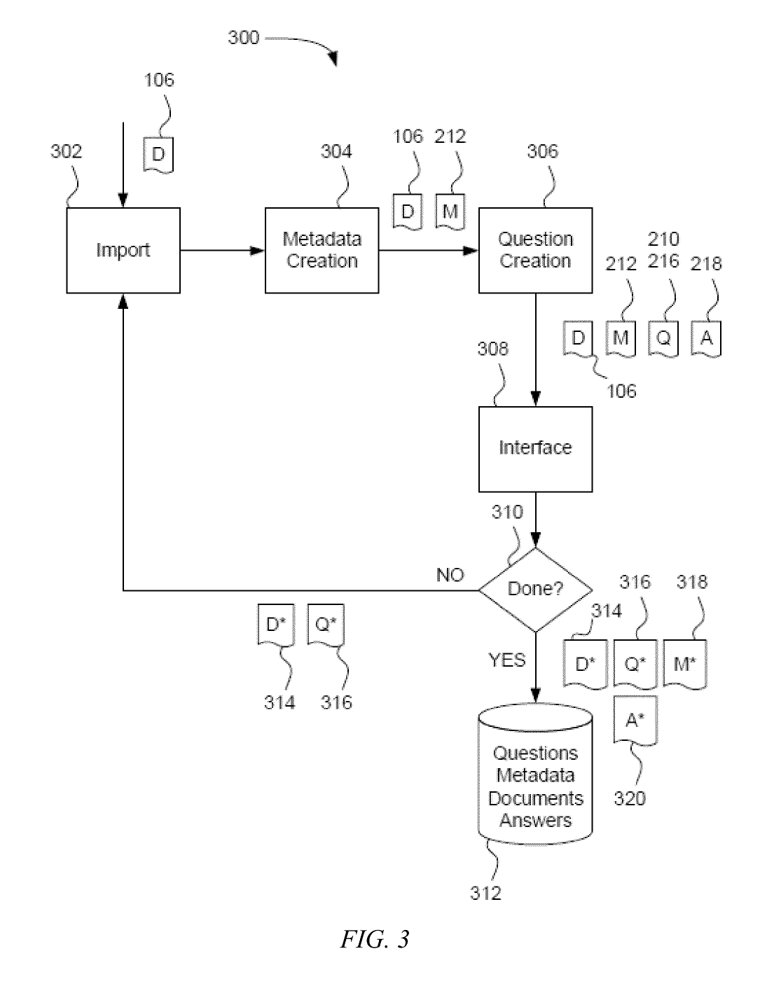

FIG. 3 depicts a flowchart diagram of one embodiment of a method 300 for question/answer creation for a document 106. Although the method 300 is described in conjunction with the QAC system 100 of FIG. 1, the method 300 may be used in conjunction with any type of QAC system 100.

In one embodiment, the QAC system 100 imports 302 one or more electronic documents 106 from a corpus 208 of data. This may include retrieving the documents 106 from an external source, such as a storage device in a local or remote computing device 104. The documents 106 may be processed so that the QAC system 100 is able to interpret the content of each document 106. This may include parsing the content of the documents 106 to identify questions found in the documents 106 and other elements of the content, such as in the metadata associated with the documents 106, questions listed in the content of the documents 106, or the like. The system 100 may parse documents using document markup to identify questions. For example, if documents are in extensible markup language (XML) format, portions of the documents could have XML question tags. In such an embodiment, an XML parser may be used to find appropriate document parts. In another embodiment, the documents are parsed using native language processing (NLP) techniques to find questions. For example, the NLP techniques may include finding sentence boundaries and looking at sentences that end with a question mark or other methods. The QAC system 100 may use language processing techniques to parse the documents 106 into sentences and phrases, for example.

In one embodiment, the content creator creates 304 metadata 212 for a document 106, which may contain information related to the document 106, such as file information, search tags, questions created by the content creator, and other information. In some embodiments, metadata 212 may already be stored in the document 106, and the metadata 212 may be modified according to the operations performed by the QAC system 100. Because the metadata 212 is stored with the document content, the questions created by the content creator may be searchable via a search engine configured to perform searches on the corpus 208 of data, even though the metadata 212 may not be visible when the document 106 is opened by a content user. Thus, the metadata 212 may include any number of questions that are answered by the content without cluttering the document 106.

The content creator may create 306 more questions based on the content, if applicable. The QAC system 100 also generates candidate questions 216 based on the content that may not have been entered by the content creator. The candidate questions 216 may be created using language processing techniques designed to interpret the content of the document 106 and generate the candidate questions 216 so that the candidate questions 216 may be formed using natural language.

When the QAC system 100 creates the candidate questions 216 or when the content creator enters questions into the document 106, the QAC system 100 may also locate the questions in the content and answer the questions using language processing techniques. In one embodiment, this process includes listing the questions and candidate questions 216 for which the QAC system 100 is able to locate answers 218 in the metadata 212. The QAC system 100 may also check the corpus 208 of data or another corpus 208 for comparing the questions and candidate questions 216 to other content, which may allow the QAC system 100 to determine better ways to form the questions or answers 218. Examples of providing answers to questions from a corpus are described in U.S. Patent Application Publication No. 2009/0287678 and U.S. Patent Application Publication No. 2009/0292687, which are herein incorporated by reference in their entirety.

The questions, candidate questions 216, and answers 218 may then be presented 308 on an interface to the content creator for verification. In some embodiments, the document text and metadata 212 may also be presented for verification. The interface may be configured to receive a manual input from the content creator for user verification of the questions, candidate questions 216, and answers 218. For example, the content creator may look at the list of questions and answers 218 placed in the metadata 212 by the QAC system 100 to verify that the questions are paired with the appropriate answers 218, and that the question-answer pairs are found in the content of the document 106. The content creator may also verify that the list of candidate questions 216 and answers 218 placed in the metadata 212 by the QAC system 100 are correctly paired, and that the candidate question-answer pairs are found in the content of the document 106. The content creator may also analyze the questions or candidate questions 216 to verify correct punctuation, grammar, terminology, and other characteristics to improve the questions or candidate questions 216 for searching and/or viewing by the content users. In one embodiment, the content creator may revise poorly worded or inaccurate questions and candidate questions 216 or content by adding terms, adding explicit questions or question templates that the content answers 218, adding explicit questions or question templates that the content does not answer, or other revisions. Question templates may be useful in allowing the content creator to create questions for various topics using the same basic format, which may allow for uniformity among the different content. Adding questions that the content does not answer to the document 106 may improve the search accuracy of the QAC system 100 by eliminating content from the search results that is not applicable to a specific search.

After the content creator has revised the content, questions, candidate questions 216, and answers 218, the QAC system 100 may determine 310 if the content finished being processed. If the QAC system 100 determines that the content is finished being processed, the QAC system 100 may then store 312 the verified document 314, verified questions 316, verified metadata 318, and verified answers 320 in a data store on which the corpus 208 of data is stored. If the QAC system 100 determines that the content is not finished being processed—for example if the QAC system 100 determines that additional questions may be used—the QAC system 100 may perform some or all of the steps again. In one embodiment, the QAC system 100 uses the verified document and/or the verified questions to create new metadata 212. Thus, the content creator or QAC system 100 may create additional questions or candidate questions 216, respectively. In one embodiment, the QAC system 100 is configured to receive feedback from content users. When the QAC system 100 receives feedback from content users, the QAC system 100 may report the feedback to the content creator, and the content creator may generate new questions or revise the current questions based on the feedback.

FIG. 4 depicts a flowchart diagram of one embodiment of a method 400 for question/answer creation for a document 106. Although the method 400 is described in conjunction with the QAC system 100 of FIG. 1, the method 400 may be used in conjunction with any QAC system 100.

The QAC system 100 imports 405 a document 106 having a set of questions 210 based on the content of the document 106. The content may be any content, for example content directed to answering questions about a particular topic or a range of topics. In one embodiment, the content creator lists and categorizes the set of questions 210 at the top of the content or in some other location of the document 106. The categorization may be based on the content of the questions, the style of the questions, or any other categorization technique and may categorize the content based on various established categories such as the role, type of information, tasks described, and the like. The set of questions 210 may be obtained by scanning the viewable content 214 of the document 106 or metadata 212 associated with the document 106. The set of questions 210 may be created by the content creator when the content is created. In one embodiment, the QAC system 100 automatically creates 410 at least one suggested or candidate question 216 based on the content in the document 106. The candidate question 216 may be a question that the content creator did not contemplate. The candidate question 216 may be created by processing the content using language processing techniques to parse and interpret the content. The system 100 may detect a pattern in the content of the document 106 that is common for other content in the corpus 208 to which the document 106 belongs, and may create the candidate question 216 based on the pattern.

The QAC system 100 also automatically generates 415 answers 218 for the set of questions 210 and the candidate question 216 using the content in the document 106. The QAC system 100 may generate the answers 218 for the set of questions 210 and the candidate question 216 at any time after creating the questions and candidate question 216. In some embodiments, the answers 218 for the set of questions 210 may be generated during a different operation than the answer for the candidate question 216. In other embodiments, the answers 218 for both the set of questions 210 and the candidate question 216 may be generated in the same operation.

The QAC system 100 then presents 420 the set of questions 210, the candidate question 216, and the answers 218 for the set of questions 210 and the candidate question 216 to the content creator for user verification of accuracy. In one embodiment, the content creator also verifies the questions and candidate questions 216 for applicability to the content of the document 106. The content creator may verify that the content actually contains the information contained in the questions, candidate question 216, and respective answers 218. The content creator may also verify that the answers 218 for the corresponding questions and candidate question 216 contain accurate information. The content creator may also verify that any data in the document 106 or generated by the QAC system 100 in conjunction with the QAC system 100 is worded properly.

A verified set of questions 220 may then be stored 425 in the document 106. The verified set of questions 220 may include at least one verified question from the set of questions 210 and the candidate question 216. The QAC system 100 populates the verified set of questions 220 with questions from the set of questions 210 and candidate questions 216 that are determined by the content creator to be accurate. In one embodiment, any of the questions, candidate questions 216, answers 218, and content that is verified by the content creator is stored in the document 106, for example, in a data store of a database.

In one embodiment, the QAC system 100 is also configured to receive feedback related to the document 106 from content users. The system 100 may receive an input from the content creator to create a new question corresponding to the content in the document 106 and based on the feedback. The system 100 may then automatically generate answers 218 for the new question using the content in the document 106. The content creator may also revise at least one question from the set of questions 210 and candidate questions 216 to correctly reflect the content in the document 106. The revision may be based on the content creator's own verification of the questions and candidate questions 216 or the feedback from content users. Although other embodiments of the method may be used in conjunction with the QAC system 100, one embodiment of the method used in conjunction with the QAC system 100 as described herein is shown below:
1. The content creator determines use cases.
2. The content is created.
3. The content creator lists and categorizes the questions that are answered in the content at the top of the content topic.
4. The system scans the title of the document and the question list.
5. The system locates a question based on the question list and locates the answer to the question.
6. The system lists the questions that can be answered based on the document/content.
7. The system lists the candidate questions that can possibly be created.
8. The system checks the corpus to which the content/document belongs to see how other content in the corpus answers the same questions.
9. The content creator revises the content, for example, by adding terms, adding explicit questions/question templates that the content answers, or adding explicit questions/question templates that the content does not answer.

An example following the steps of the method described above includes:
1. A use case includes “Importing a document into a requirements project.”
2. The content is a document accessible via a document search.
3. The content creator (document author) creates questions that are answered at the top of the document:
   a. “How do I import a document into a requirements project?”
   b. “How do I get a <specific document type> into the requirements project?”
4. The system checks that the questions from step 3 are included in the document or question list corresponding to the document.
5. The system answers the questions using the document content. For example, there is a perfect match for question (a) in the document title, and there may be a conditional match for the question (b).
6. The system lists other questions that are answered by the content. These may include questions not already listed, which may be based on common patterns for the corpus (or other sources) that are detected in the document by the system.
   a. For example, the system returns the question “What's the difference between ‘the content is converted into a rich-text format’ and ‘the process of uploading a file’?” based on the following document content:
   b. “When you import a document, the content is converted into a rich-text format. This differs from the process of uploading a file.”
7. The system also suggests candidate questions that may be answered by the document. For example, candidate questions may be based on the proximity of words in the document. Thus, the system may detect the proximity of “import” to words describing document types. Some natural language processing may be used to avoid mistakes. For example, if the content contains “The system currently does not support imports of .avi or other movie content,” the system may detect the negative statement. With this caveat, for the content:
   a. “You can import these document types:
      <document type 1>
      <document type 2>
      <document type 3>”
   b. The system generates 3 questions:
      i. “How do I import <document type 1>?”
      ii. “How do I import <document type 2>?”
      iii. “How do I import <document type 3>?”
8. The system checks other documents in the corpus to which the specific document belongs to answer the candidate questions.
9. The author adjusts the question list. For example, for the question listed in (4)(a), the author changes the question to “What's the difference between ‘importing a document’ and ‘the process of uploading a file’?” because the original question generated by the system was inaccurate based on the document content. The author may adjust any of the questions created previously by the author or generated by the system. In one embodiment, editing is achieved by leveraging a user interface with regular expressions for alternatives or by checklists.

As mentioned above, the QAC system may determine relationships between content of documents and associate questions specified in the header or metadata information associated with documents, in a corpus of content, e.g., the collection of electronic documents upon which the question and answer creation system operates. The present invention also provides mechanisms for identifying information gaps in content, e.g., electronic documents, of the corpus of content used by question and answer creation (QAC) systems. These additional mechanisms of the present invention combines the information gathered using a QAC system with regard to questions and answers in electronic documents, with information gathered from content analysis mechanisms, such as textual analysis engines including natural language processing, keyword extraction, textual pattern matching, or the like, and metadata analysis, e.g., metadata tag analysis, to identify the actual content coverage of the electronic documents, expected content coverage based on results of the various analysis, and the difference between the expected and actual content coverage which is indicative of potential information gaps in the content of the electronic documents. This may be done not only on an individual electronic document basis, but across a corpus of content, as will be described hereafter.

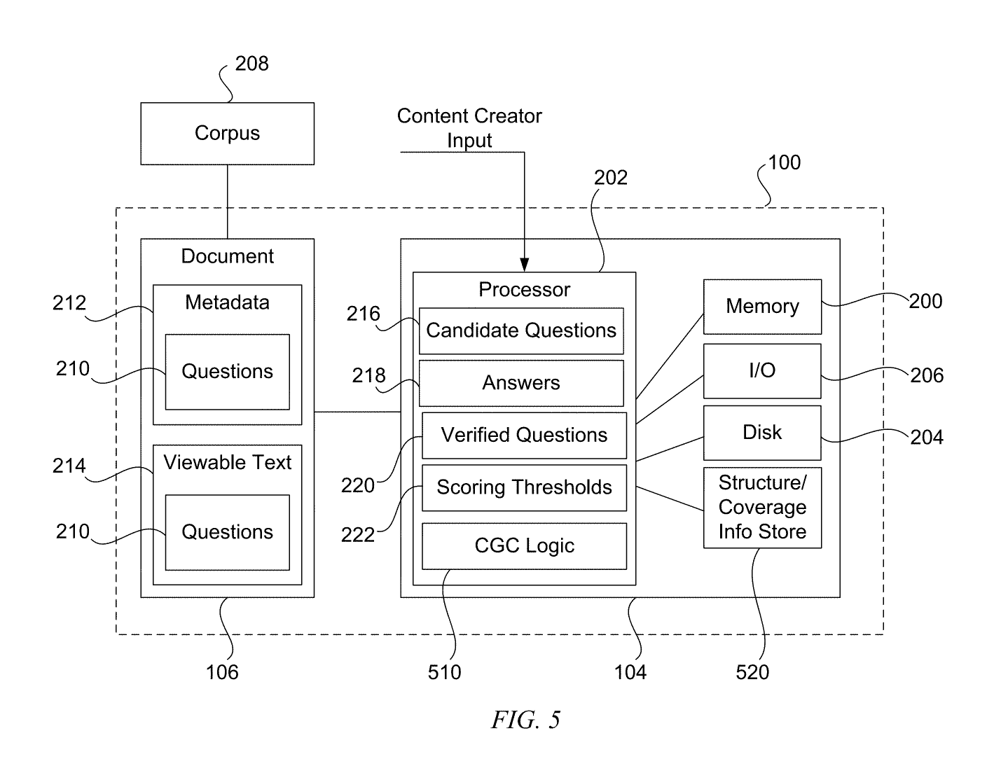

As shown in FIG. 5, with these additional mechanisms of the illustrative embodiments, additional content gap checking (CGC) logic 510 is provided in the processor 202. The CGC logic 510 utilizes structure and coverage information storage 520 to assist in the CGC logic 510 operations for identifying information gaps in an electronic document or content. The CGC logic 510 may work in parallel with, or on the results of, the operation of the processor 202 with regard to question and answer creation as previously described above with reference to FIGS. 1-4. In identifying information gaps in a portion of content, e.g., an electronic document, the CGC logic 510 utilizes an analysis of the portion of content and the structure and coverage information from the structure and coverage information store 520 to determine what questions the QAC system 500 expects to find answers for in the content and the extent of coverage of a topic found in the content. The CGC logic 510 may then determine if various types of information gaps are present in the content and if the content provides sufficient coverage of the topics contained therein, and may report such results to the content author, user, provider, or the like, so that appropriate modifications of the content may be performed.

More specifically, the CGC logic 510 may utilize the QAC system previously described above with reference to FIGS. 1-4 to identify and extract questions and topics (QT) in the content, i.e. generate questions and generate topic classifications identifying the topics addressed in the content of the electronic document as may be determined from natural language analysis, keyword and phrase identification, or the like. As a result, a collection of questions and topics (QT) data are produced. Such QT data may be identified and extracted from metadata associated with the content, specific portions of the content such as titles, summaries, abstracts, etc., in accordance with a configuration of the CGC logic 510 specifying the structure tags of electronic documents, portion identifiers, or the like, which are to be used as indicators of portions of the document to be analyzed for such QT data production.

The QT data is checked against the content and the corpus of content for various types of information gaps using the structure and coverage information from the structure and coverage information store 520. The structure and coverage information store 520 provides information regarding the structure of the content, e.g., metadata specifying tags identifying structured portions of the content such as “/title,” “/summary”, “/image” or the like. The structure and coverage information store 520 may further specify what is included in the content, e.g., questions answered by the content, topics of the content, classifications of the content, and the like. The structure and coverage information store 520 may be a separate data structure or may be integrated with the content itself. In the description hereafter, it should be appreciated that references to “metadata” of the content or electronic document is in reference to such metadata that may be part of the structure and coverage information store 520.

Furthermore, where functions are described hereafter with regard to analyzing the metadata of the content or electronic document, it should be appreciated that alternative analysis can be performed by the CGC logic 510 on content and/or electronic documents that are not structured using information in the structure and coverage information store 520. While this analysis may be more complex, the CGC logic 510 may be configured with algorithms and logic for performing such analysis on unstructured content using pattern matching, keyword matching, image analysis, or any known analysis techniques for extracting information from unstructured content.

Examples of the types of information gaps that may be identified by the CGC logic 510 based on the operation of the QAC logic and further content and metadata analysis include, but are not limited to, the following types of information gaps:

Section content that does not match container content indications;

Incomplete coverage of logically related operations;

Pre-requisites inconsistently listed for similar tasks;

Topics with similar content that could be linked but are not;

Inconsistencies in topic types and content (concept, task, reference);

Missing and inconsistent definitions for terms and acronyms; and

Missing information that is potentially conveyed in an image but not alternative text.

With regard to section content that does not match container content indications, what is meant is that the topics identified for the content as a whole, or a parent section of the container may or may not be matched by sub-sections of the content. For example, if a container content topic is “importing a document” but a subsection of the content is directed to “formatting pictures,” without any discussion of importing documents, then the topics may be considered sufficiently different that there is an information gap. Such topic identification can be performed in a number of different ways including natural language processing (NLP) analysis, keyword or key phrase extraction algorithms, or the like. The resulting topics may then be compared to determine any correspondence or non-correspondence between topics associated with the various containers and sub-sections.

With regard to incomplete coverage of logically related operations, what is meant is that a portion of content may make reference to some questions/topics but not mention or provide sufficient coverage of related topics, such as topics/sub-topics, antonyms, synonyms, or the like. Thus, the CGC logic 510 may be configured to have a listing of related topics/sub-topics, synonyms, antonyms, and the like. Thus, when one topic, keyword, key phrase, or term is identified in the content, a determination can be made as to whether the related topic, keyword, key phrase, or term listed in the CGC logic 510 is present in the content of the document. Based on this determination, a determination as to whether an information gap is present or not, e.g., an information gap may exist when the related topic, keyword, key phrase, or term is not present within the content of the document.

With regard to pre-requisites inconsistently listed for similar tasks, what is meant is that content may state, in different portions of the content, tasks and their pre-requisites. The CGC logic 510 may be configured to determine if there are any inconsistencies between the pre-requisites stated for similar tasks, in which case there may be an information gap present. For example, a task may be described as having a prerequisite of A and B in one portion of the document and in another portion, the pre-requisites may be specified as being A, C, and D. Thus, there is an inconsistency and a potential information gap in the document.

Regarding topics with similar content that could be linked but are not, the CGC logic 510 may be configured to identify when topics are separately addressed in the content but are related and are not linked by references to the other topics. For example, the CGC logic 510 may be configured with listings of linked topics, similar to antonyms, synonyms, and the like above, such that even if the topics are both present in the document, if they do not have any references to one another or specific hypertext links to one another, then such situations may be identified by the CGC logic 510 as potential information gaps.

Regarding inconsistencies in topic type, the CGC logic 510 may be configured to identify when the stated classification of a topic in the document, such as in the metadata or a header portion of the document, is inconsistent with the treatment of the topic within the content of the document. As one example of this issue, if the type of topic was indicated, such as with metadata, as a “concept” type of topic, but the content of document directed to this topic included procedures, then the content would suggest that the topic was in fact a task rather than a concept.

With regard to missing and inconsistent definitions for terms and acronyms, the CGC logic 510 may determine when terms are utilized that should have corresponding descriptions but do not and when acronyms are used but their long forms are not presented in the content. The identification of terms that required descriptions may be done in a number of different ways including, amongst others, using a listing of terms that should have corresponding definitions, for example. More complex analysis including using an electronic dictionary to identify terms in content for which a corresponding dictionary definition is not present may be performed. With regard to the use of acronyms, the content of the document may be parsed to identify the presence of acronyms based on the textual patterns associated with acronyms (terms that are not recognizable words, are in all caps, and the like) and the sentence structure before and/or after the acronyms may be analyzed to determine if the corresponding expansion of the acronym is present or has been previously presented in the document.

Regarding missing information that is potentially conveyed in an image but not provided in alternative text, the CGC logic 510 may be configured to identify images in content and determine whether these images have corresponding alternative text to describe the image. That is, the content of the document may be analyzed to determine if a pattern of data corresponds to a pattern indicative of an image, a reference to a specific type of file in the code of the document (e.g., BMP, JPG, etc.), or the like, to identify the image in the document. The data and/or coding of the document may also be analyzed to determine if there is any metadata, textual description, or the like, associated with the identified images, such as via tags in the coding, descriptions in close proximity to the images, or the like. If not, then an information gap may be present.

In addition, the CGC logic 510 may identify specific possible information gaps in the form of missing or incomplete alternative text when the content of a topic is flagged as incomplete. In other words, the feedback about an information gap for a topic can point to the image as a possible source of the issue.

Thus, various types of potential information gaps may be identified by the CGC logic 510. These are only examples. The CGC logic 510 may be configured to identify other types of information gaps either in addition to, or in replacement of, the information gap types described herein. This configuration of the CGC logic 510 may be performed based on the information stored in the structure and coverage information storage 520. This information may be in the form of rules having conditions and related actions, e.g., conditions identifying a particular type of information gap, and an action to log or otherwise report the potential information gap.

The QT data is also checked against the content and corpus of content to determine if the QT data is better covered in the corpus or that implicit knowledge of the corpus is required. That is, the QT data may be treated as a question set for the corpus and a determination is made as to whether the corpus gives higher scored answers than the content which is indicative that there is better coverage in the corpus than in the content. One way of generating these scores for the document and the corpus is to use the scores of answers and if they are below a threshold score value, an information gap is determined to exist. Any suitable mechanism for scoring answers to questions may be used without departing from the spirit and scope of the illustrative embodiments.

Moreover, elements of the QT may be decomposed into sub-elements qt1 and qt2 where qt1 is answered from the content and qt2 is answered from the corpus. In such a case, this indicates that some implicit knowledge of the corpus is potentially required.

The results of these operations are sent to the content author, user, or provider to assist the content provider in identifying revisions to be made to the content, structure of the content, or the like. That is, indications of the particular gaps in information may be provided and indications as to whether the corpus or the content provides a better source of an answer for the particular questions, or if an implicit knowledge of the corpus is required, may be provided to the content provider. As a result of this information being reported back to the content author, user, or provider, the content may be modified and the process may be repeated for the modified content. For example, if the information reported back to the content author, user, or provider indicates that there is a gap in information regarding installing a program, then the content provider may add a section to the content to address this topic and thus, provide an answer to a question expected to be answered by the content. If the information reported back indicates that there is an implicit knowledge of the corpus expected in the content, the content author may modify the content to make such knowledge explicit in the content, add links to other sources of information in the corpus of content, or the like. Other modifications based on the specified gaps in information and coverage of the content may be made without departing from the spirit and scope of the illustrative embodiments.

As mentioned above, the CGC logic 510 may make use of the questions and topics identified by the QAC system and further use knowledge of the structure and coverage concepts stored in the structure and coverage store 520 to identify the gaps in information and the scope of coverage of the content and the corpus of content with regard to these questions and topics. Thus, the structure and coverage information store 520 stores information for configuring the CGC logic 510 in determining the structure of content and the coverage of the content with regard to questions and topics. This information may be presented in the form of rules having conditions and associated actions, e.g., if there is a first topic, and the related topic is not present, then the action may be to mark or log this portion of content, this topic, or the like, as having a potential information gap and the type of information gap. This information may be used not only by the CGC logic 510 but also by the QAC system as a whole when determining questions and corresponding questions. For purposes of explaining the use of this structure and coverage information in determining possible gaps of information, consider a portion of content in which the QAC system has identified the following subset of topics:

1. Importing and Exporting Files
1a. Importing documents into a requirements project
1b. Creating PDF and Microsoft Word Documents from Artifacts
1c. Importing CSV Files into a Requirements Project
1d. Creating CSV Files
1e. Exporting Requirement Artifacts to a CSV File

The structure and coverage information store 520 may store any structure and/or coverage information for configuring the CGC logic 510 to identify relationships between portions of content and topics within the content. For example, the structure and coverage information store 520 stores information regarding parent to child hierarchical structures, completeness information, prerequisite information, task and concepts information, acronyms and terminology information, and common-shared value information. With regard to parent to child hierarchical structures, in one illustrative embodiment, this information provides the CGC logic 510 with knowledge of architectural concepts of content, such as the concept that parent, child, and sibling topics should cover information that is related and that child topics typically expand on parent topic content by being more specific than the parent topic. Related topics and parent/child topic associations may be specifically identified in listings of topics provided to the CGC logic 510 or otherwise identified through analysis of the corpus of content, e.g., if a particular topic and subtopic are found to exist in the corpus of content in relation to each other more than a threshold amount of time (e.g., more than X % of the time that these topics/subtopics are present, they are within a same document, or within a threshold distance of each other in the same document or in related documents), then these topics/subtopics may be considered related to each other and a similar analysis can be performed with regard to parent/child relationships between related topics/subtopics.

Based on this configuration of the CGC logic 510, and the identified QT data from the content being analyzed, the CGC logic 510 can analyze the parent and child topics to determine if these parent, child, and sibling topics cover information that is related and that child topics expand on parent topics. Thus, the CGC logic 510 can determine based on the QT data whether a child or sibling topic is directed to a topic that is not related to the parent topic or not. If it is not related, an information gap may be determined to exist either in terms of a parent topic for the child or sibling topic. Moreover, if an expected child or sibling topic is not present, then an information gap may also be determined to exist in the child/sibling topics of the document.

For example, assume that the CGC logic 510 finds a topic “Importing and Exporting Files” in the example above, with a short description that covers import and export in the content. Based on this, the CGC logic 510 posts information on importing and exporting files or documents into a topic set, such as the QT data mentioned above, with a strong confidence measure associated with it. The confidence measure is an example of a scoring that is associated with the document and may be generated using various scoring methodologies based on an analysis of the content of the document, e.g., giving various score values for places in the document where the topic is referenced, weighting these score values based on where in the document these topics are referenced, how often the topic is referenced, how, where and how often related topics/subtopics are referenced in the document, etc.

The CGC logic 510 analyzes the child topics and finds titles and labeled steps with content that consistently mentions importing and exporting files, i.e. the sub-topics in the example above refer to the exporting and/or importing of documents/files. As a result, the CGC logic 510 determines that indicators are good that the topic set (QT data for the document) includes content that matches the expectations of the parent (or container) topic. If any of these topics were missing, this is an indication of a gap in information.

The completeness information provides the CGC logic 510 with knowledge of topics that are related, such as antonyms, synonyms, related terms, or the like. For example, the completeness information provides the CGC logic 510 with knowledge that the topic “export” is the antonym of “import” such that if the CGC logic 510 finds the export topic in the content, the CGC logic 510 expects to find the “import” topic nearby in the content. Similarly, the topics of “install” and “uninstall” are known to be related topics. Thus, if the CGC logic 510 finds one topic but not the related topic, then this is indicative of a possible information gap. The completeness information in the configuration information for the CGC logic 510 may provide a listing of such terms and their antonyms, synonyms, related terms, or the like.

The prerequisite information provides the CGC logic 510 with knowledge of when one task specified in content is likely to apply to another task due to similarity of content. That is, the QAC system is configured to identify tasks with similar content and the CGC logic 510 may determine that these tasks having similar content may or may not have associated pre-requisites specified in the content or metadata associated with these tasks. The identification of tasks may be done by analyzing metadata associated with the content, the metadata having tags that specify topics. These metadata tags may further include one or more designations of the particular tasks which may be compared by the CGC logic 510 to identify matching task designations which are considered to be tasks having similar content. Similarly, the metadata may further include task pre-requisite tags that specify pre-requisites for the corresponding tasks. Of course, as noted above, some content may not be structured using metadata or tags for designating particular portions of the content or electronic document in which case analysis of the content may be performed to identify patterns of information indicative of tasks, pre-requisites, and the like, e.g., an enumerated listing is indicative of a task, the terms “pre-requisite” or “required” or “prior to” or the like may be indicative of a pre-requisite, etc.

Thus with regard to inconsistently described pre-requisites, for example, there may be parallel topics associated with using the Microsoft Word™ word processing program. One topic may be regarding importing Word™ documents into a requirements project, and the other topic may be regarding exporting requirement projects artifacts to a Word™ document. In the first topic, a prerequisite may be listed that one must use Microsoft Word™ 2003 or later. However, this prerequisite may not be included in the second topic. The CGC logic 510 may identify these related tasks and that fact that there is a pre-requisite in one and not the other. As a result, the CGC logic 510 may flag this as a potential information gap that should be identified to the content user, author, or provider.

The topic types and structure information in the structure and coverage information 520 provides the CGC logic 510 with knowledge of topic types, e.g., concept, task, reference, etc., and allows the CGC logic 510 to track this designation using the topic metadata and title construction. For example, the documents themselves may have metadata, tags, or other content/structural information that identifies the topic types, e.g., a metadata tag of /concept, or /task, or the like, may be included in the document to identify portions of the document as being associated with a topic type. Taking an example previously presented, a topic may includes the metadata term “/task” and uses the title “Importing CSV files into a requirements project.” The short description or topic introduction is may be of the type “one can import the contents of a comma-separated values (CSV) file from your file system to a requirements project to make it available to other users.” All of these clues indicate a task topic. A procedure and steps would also be expected in the body of the topic.

The tasks and concepts information provides the CGC logic 510 with information that, for task topics, the CGC logic 510 expects that the title, short description, and step introduction will all describe a similar task. Moreover, the tasks and concepts information informs the CGC logic 510 that task topic titles should start with a gerund and concept titles use a noun or noun phrase. Thus, for example, if the CGC logic 510 finds the content to have a short description that is very different from the title and step introduction, then a gap in information may be identified. Moreover, if the CGC logic 510 finds a topic tagged to be a “concept” but with a gerund title, such as “Creating CSV files”, then a gap in information may also be identified. Thus, the metadata tag is an indicator of topic type and there are other clues, such as title construction, short description or topic introduction, and topic body content such as a procedure for a task or highly structured text in a reference topic, that all provide clues as to the structure and content of the document. Any disharmony for a particular topic, with mismatches, would indicate a possible information gap. Thus, the CGC logic 510 may analyze the task topic titles, concept topics, and the like to see if they meet the requirements set forth in the tasks and concepts information configuration of the CGC logic 510.

Thus, this structure and coverage information store 520 may be used by the CGC logic 510 to perform the QT checks against the content and the corpus of content to identify information gaps and to determine whether the content or the corpus of content has better coverage and if there is an implicit knowledge of the corpus required in the content. For example, when determining if there are information gaps in the content, the CGC logic 510 may determine, considering the topics and their context, what information would a user expect to find in the content and what information is missing or inconsistent. As an example, if the topic of the document is a procedure, the CGC logic 510 would expect “steps” to be mentioned in the content. A pattern comprising an action verb (determined from parsing the content), the words “as follows”, and a list of list element tags <:li.> can be associated with steps. Some of the patterns can be predefined as above, others can be learned from a corpus of data having questions and answers, where the questions are “how do/does Pone . . . ” As another example, if the topic is a question (as in a FAQ title), then the CGC logic 510 would expect an answer to contain a best answer (one having a confidence score as the correct answer) to the question.

With regard to determining the best coverage, the CGC logic 510 may determine, for the information that is provided in the content, if the information is structured and typed appropriately. For example, the CGC logic 510 may have access to frames, i.e. typical predicate-argument structures, which may be provided from resources similar to FrameNet, and from Prismatic-like resources. Thus, the CGC logic 510 may evaluate the content to determine when container indicators use verbs, e.g., “import,” “create”, etc., satisfy these predicate-argument structure frames and may determine how much overlap there is between expected frames and the content. A threshold value of overlap may be used to flag content with missing frames or frame elements. For example, the verbs “upload” and “import” may have similar frame arguments that are “upload/import DOCUMENT/FILE”. Therefore documents explaining import potentially might explain questions about uploading. Whether and how well they do answer such questions is determined by the whole QAC system as previously described above.

As part of the best coverage determination, the CGC logic 510 may also determine when there are semantically related terms in the content. If a term is present in the content and its semantically related term is not present in the content, then a determination of an information gap may be identified. For example, if the content comprises the term “import” but does not contain information about “export”, then an information gap may be flagged in the content.

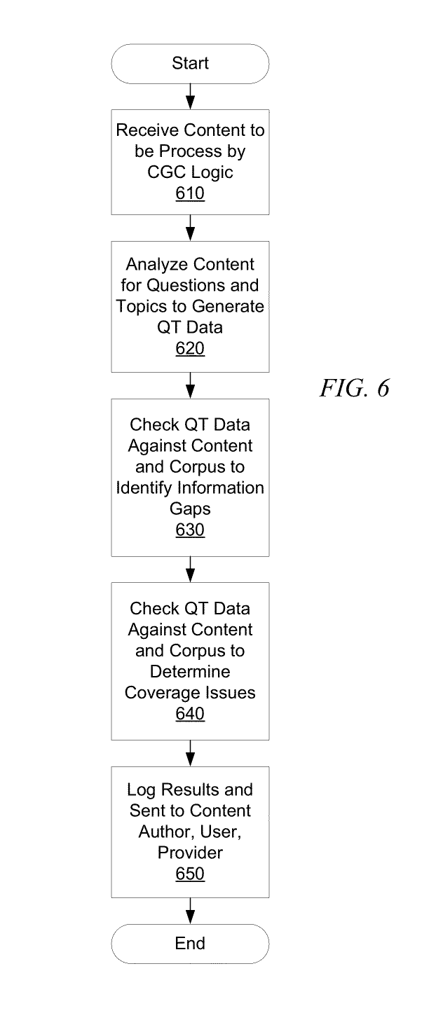

FIG. 6 is a flowchart diagram outlining an example operation for performing content gap checking in accordance with one illustrative embodiment. The operation outlined in FIG. 6 may be implemented, for example, by CGC logic 510 in FIG. 5, for example, in conjunction with the identification of questions, answers, and topics by the QAC system described previously with regard to FIGS. 1-4.

As shown in FIG. 6, the operation starts receiving content, e.g., an electronic document or the like, to be processed by the content gap checking logic (step 610). The content is analyzed for topics and questions which are extracted, such as in the manner described above with regard to FIGS. 1-4, to generate a collection of questions and topics, i.e. QT data (step 620). The QT data is checked against the content and the corpus of content for information gaps that the content gap checking logic is configured to identify (step 630). The QT data is also checked against the content and the corpus of content to identify whether the QT data is better covered in the corpus than in the content, or that an implicit knowledge of the corpus is required in the content (step 640). The results of steps 630 and 640 are logged and/or sent to the content author, user, or provider to notify the author, user, or provider of the potential information gap and topic coverage issues identified (step 650). The operation then terminates. It should be appreciated that this process may be repeated on additional content presented to the content gap checking logic. In addition, the content author, user, or provider may modify their content and resubmit it to the content gap checking logic to be rechecked.

Thus, the illustrative embodiments provide mechanisms for not only identifying questions and answers within content, but also may determine information gaps in the content and coverage issues with regard to identified topics in the content. As a result, content authors, users, and providers may be informed of these information gaps and content issues so that they may modify their content to address any such information gaps and/or coverage issues to provide better and more comprehensive content.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for identifying information gaps in electronic content, comprising:
receiving, in the data processing system, the electronic content to be analyzed;
analyzing, by the data processing system, the electronic content to identify at least one of topics or questions within the electronic content to produce a collection of at least one of topics or questions associated with the electronic content;
comparing, by the data processing system, the collection to the electronic content, and to a corpus of previously analyzed electronic content, to produce a set of information gaps in the electronic content; and
outputting, by the data processing system, a notification of the set of information gaps to a user associated with the electronic content.

2. The method of claim 1, wherein if the previously analyzed electronic content provides a higher scored answer for a question in the collection, than a score for an answer to the question in the electronic content, an information gap is detected.

3. The method of claim 1, wherein the set of information gaps is selected from the group consisting of section content that does not match container content indications, incomplete coverage of logically related operations, prerequisites inconsistently listed for similar tasks, topics with similar content that could be linked but are not, inconsistencies in topic types and content, and missing and inconsistent definitions of terms and acronyms.

4. The method of claim 1, wherein comparing comprises determining that the collection contains a first subset of questions which has a higher scored answer from the previously analyzed electronic content and a second subset of questions which has a higher scored answer from the electronic content, to produce an indication that implicit knowledge of the previously analyzed electronic content is potentially required to understand the electronic content.

5. The method of claim 1, wherein comparing the collection to the electronic content and to a corpus of previously analyzed electronic content, to produce a set of information gaps in the electronic content comprises:
comparing a parent topic of the electronic content to at least one of a child topic or a sibling topic to determine whether the at least one of a child topic or sibling topic is related to the parent topic;
in response to a determination that the at least one of a child topic or sibling topic is not related to the parent topic, determining that a topic mismatch information gap exists; and
adding an identifier of the topic mismatch information gap to the set of information gaps in response to a determination that a topic mismatch information gap exists.

6. The method of claim 1, wherein comparing the collection to the electronic content, and to a corpus of previously analyzed electronic content, to produce a set of information gaps in the electronic content comprises:
comparing topics found within the electronic content to a listing of related topics;
determining whether a related topic, in the listing of related topics, corresponding to the topics found within the electronic content, is also present in the electronic content;
determining that a related topic information gap exists in the electronic content in response to a determination that the related topic is not present in the electronic content; and
adding an identifier of the related topic information gap to the set of information gaps in response to a determination that a related topic information gap exists.

7. The method of claim 1, wherein comparing the collection to the electronic content, and to a corpus of previously analyzed electronic content, to produce a set of information gaps in the electronic content comprises:
comparing task topics found within the electronic content, as part of the identified topics in the electronic content, to each other to identify related task topics in the electronic content;
determining whether one or more of the task topics comprises a pre-requisite;
determining whether one or more related task topics in the electronic content do not comprise the pre-requisite to identify a pre-requisite information gap; and
adding an identifier of the pre-requisite information gap to the set of information gaps in response to a determination that a pre-requisite information gap exists.

8. The method of claim 1, wherein comparing the collection to the electronic content, and to a corpus of previously analyzed electronic content, to produce a set of information gaps in the electronic content comprises:
comparing topics found within the electronic content, as part of the identified topics in the electronic content, to each other to identify related topics that should be linked but are not linked within the electronic content;
determining whether one or more related topics in the electronic document are not linked within the electronic content to identify a linked topic information gap; and
adding an identifier of the linked topic information gap to the set of information gaps in response to a determination that a linked topic information gap exists.

9. The method of claim 1, wherein comparing the collection to the electronic content, and to a corpus of previously analyzed electronic content, to produce a set of information gaps in the electronic content comprises:
comparing topics found within the electronic content, as part of the identified topics in the electronic content, to each other to similar topics classified as different types of topics;
determining whether one or more similar topics in the electronic document are specified as having a different topic type to identify a topic type inconsistency information gap; and
adding an identifier of the topic type inconsistency information gap to the set of information gaps in response to a determination that a topic type inconsistency information gap exists.

10. The method of claim 1, wherein comparing the collection to the electronic content, and to a corpus of previously analyzed electronic content, to produce a set of information gaps in the electronic content comprises:
comparing terms in topics found within the electronic content, as part of the identified topics in the electronic content, to each inconsistent or missing definitions of these terms in the electronic content;
determining whether one or more inconsistent or missing definitions of terms in topics of the electronic document are present to identify a definition information gap; and
adding an identifier of the definition information gap to the set of information gaps in response to a determination that a definition information gap exists.

11. The method of claim 10, wherein the terms are acronyms.

12. The method of claim 1, wherein comparing the collection to the electronic content, and to a corpus of previously analyzed electronic content, to produce a set of information gaps in the electronic content comprises:
identifying images within the electronic content;
determining whether there is an information gap associated with alternative text associated with the images to thereby identify an image information gap; and
adding an identifier of the image information gap to the set of information gaps in response to a determination that an image information gap exists.

13. A computer program product comprising a computer readable storage medium having a computer readable program stored therein, wherein the computer readable program, when executed on a computing device, causes the computing device to:
receive electronic content to be analyzed;
analyze the electronic content to identify at least one of topics or questions within the electronic content to produce a collection of at least one of topics or questions associated with the electronic content;
compare the collection to the electronic content, and to a corpus of previously analyzed electronic content, to produce a set of information gaps in the electronic content; and
output a notification of the set of information gaps to a user associated with the electronic content.

14. The computer program product of claim 13, wherein if the previously analyzed electronic content provides a higher scored answer for a question, in the collection, than a score for an answer to the question in the electronic content, an information gap is detected.

15. The computer program product of claim 13, wherein the set of information gaps is selected from the group consisting of section content that does not match container content indications, incomplete coverage of logically related operations, prerequisites inconsistently listed for similar tasks, topics with similar content that could be linked but are not, inconsistencies in topic types and content, and missing and inconsistent definitions of terms and acronyms.

16. The computer program product of claim 13, wherein comparing comprises determining that the collection contains a first subset of questions which has a higher scored answer from the previously analyzed electronic content and a second subset of questions which has a higher scored answer from the electronic content, to produce an indication that implicit knowledge of the previously analyzed electronic content is potentially required to understand the electronic content.

17. The computer program product of claim 13, wherein comparing the collection to the electronic content, and to a corpus of previously analyzed electronic content, to produce a set of information gaps in the electronic content comprises:
comparing a parent topic of the electronic content to at least one of a child topic or a sibling topic to determine whether the at least one of a child topic or sibling topic is related to the parent topic;
in response to a determination that the at least one of a child topic or sibling topic is not related to the parent topic, determining that a topic mismatch information gap exists; and
adding an identifier of the topic mismatch information gap to the set of information gaps in response to a determination that a topic mismatch information gap exists.

18. The computer program product of claim 13, wherein comparing the collection to the electronic content, and to a corpus of previously analyzed electronic content, to produce a set of information gaps in the electronic content comprises:
comparing topics found within the electronic content to a listing of related topics;
determining whether a related topic, in the listing of related topics, corresponding to the topics found within the electronic content, is also present in the electronic content;
determining that a related topic information gap exists in the electronic content in response to a determination that the related topic is not present in the electronic content; and
adding an identifier of the related topic information gap to the set of information gaps in response to a determination that a related topic information gap exists.

19. The computer program product of claim 13, wherein comparing the collection to the electronic content, and to a corpus of previously analyzed electronic content, to produce a set of information gaps in the electronic content comprises:
comparing task topics found within the electronic content, as part of the identified topics in the electronic content, to each other to identify related task topics in the electronic content;
determining whether one or more of the task topics comprises a pre-requisite;
determining whether one or more related task topics in the electronic content do not comprise the pre-requisite to identify a pre-requisite information gap; and
adding an identifier of the pre-requisite information gap to the set of information gaps in response to a determination that a pre-requisite information gap exists.

20. The computer program product of claim 13, wherein comparing the collection to the electronic content, and to a corpus of previously analyzed electronic content, to produce a set of information gaps in the electronic content comprises:
comparing topics found within the electronic content, as part of the identified topics in the electronic content, to each other to identify related topics that should be linked but are not linked within the electronic content;
determining whether one or more related topics in the electronic document are not linked within the electronic content to identify a linked topic information gap; and
adding an identifier of the linked topic information gap to the set of information gaps in response to a determination that a linked topic information gap exists.

21. The computer program product of claim 13, wherein comparing the collection to the electronic content, and to a corpus of previously analyzed electronic content, to produce a set of information gaps in the electronic content comprises:
comparing topics found within the electronic content, as part of the identified topics in the electronic content, to each other to similar topics classified as different types of topics;
determining whether one or more similar topics in the electronic document are specified as having a different topic type to identify a topic type inconsistency information gap; and
adding an identifier of the topic type inconsistency information gap to the set of information gaps in response to a determination that a topic type inconsistency information gap exists.

22. The computer program product of claim 13, wherein comparing the collection to the electronic content, and to a corpus of previously analyzed electronic content, to produce a set of information gaps in the electronic content comprises:
comparing terms in topics found within the electronic content, as part of the identified topics in the electronic content, to each inconsistent or missing definitions of these terms in the electronic content;
determining whether one or more inconsistent or missing definitions of terms in topics of the electronic document are present to identify a definition information gap; and
adding an identifier of the definition information gap to the set of information gaps in response to a determination that a definition information gap exists.

23. The computer program product of claim 22, wherein the terms are acronyms.

24. The computer program product of claim 13, wherein comparing the collection to the electronic content, and to a corpus of previously analyzed electronic content, to produce a set of information gaps in the electronic content comprises:
identifying images within the electronic content;
determining whether there is an information gap associated with alternative text associated with the images to thereby identify an image information gap; and
adding an identifier of the image information gap to the set of information gaps in response to a determination that an image information gap exists.

25. An apparatus, comprising:
a processor; and
a memory coupled to the processor, wherein the memory comprises instructions which, when executed by the processor, cause the processor to:
receive electronic content to be analyzed;
analyze the electronic content to identify at least one of topics or questions within the electronic content to produce a collection of at least one of topics or questions associated with the electronic content;
compare the collection to the electronic content, and to a corpus of previously analyzed electronic content, to produce a set of information gaps in the electronic content; and
output a notification of the set of information gaps to a user associated with the electronic content.
